(19) United States
(12) Patent Application Publication
(10) Pub. No.: US 2026/0267275 A1
(43) Pub. Date: Sep. 10, 2026

(54) IMAGE FORMING APPARATUS

(71) Applicant: Kohga Matsuoka, Kanagawa (JP)

(72) Inventor: Kohga Matsuoka, Kanagawa (JP)

(73) Assignee: ETRIA Co., Ltd., Kanagawa (JP)

(21) Appl. No.: 19/458,720

(22) Filed: Jan. 24, 2026

(30) Foreign Application Priority Data
Mar. 7, 2025 (JP) 2025-036401

(51) Int. Cl. G03G 15/00; G03G 21/16; G03G 21/18; B65H 9/06

(52) U.S. Cl. CPC G03G 15/657; G03G 21/1633; G03G 21/1647; G03G 21/1832; B65H 9/06; G03G 2215/00675

(57) ABSTRACT

An image forming apparatus includes a body, a transfer unit, a fixing unit, an attachment member, a guide member including a guide surface to guide a sheet, a shutter to switch between a closed state where the shutter approaches the guide member and enters a sheet conveyance path, and an open state where the shutter is farther from the guide member and retracted from the path. The shutter switches to the open state in conjunction with attachment of the attachment member, and switches to the closed state in conjunction with detachment of the attachment member. The guide surface includes an upstream guide surface upstream from the shutter and downstream from the transfer unit in a sheet conveyance direction. In the closed state, an end of the shutter closer to the guide surface is placed at a portion recessed from a downstream end of the upstream guide surface in the direction.

### CROSS-REFERENCE TO RELATED APPLICATION

This patent application is based on and claims priority pursuant to 35 U.S.C. §119(a) to Japanese Patent Application No. 2025-036401, filed on Mar. 7, 2025, in the Japan Patent Office, the entire disclosure of which is hereby incorporated by reference herein.

### BACKGROUND

### Technical Field

### The present disclosure relates to an image forming apparatus.

### Related Art

As an image forming apparatus such as a copier or a printer, an electrophotographic image forming apparatus that transfers a toner image formed on a surface of a photoconductor to a sheet such as paper is known.

Typically, in an electrophotographic image forming apparatus, a fixing device that heats a toner image transferred to a sheet and fixes the toner image to the sheet is mounted. Since such a fixing device has a high temperature, a measure is required to prevent an operator from erroneously touching the fixing device at the time of maintenance or the like.

Therefore, a configuration has been proposed in which the fixing device is covered with a shutter, and the shutter is secured to a closed position (position covering the fixing device) by a lock member so that the operator does not inadvertently move the shutter.

However, when a lock member for securing the shutter to the closed position is provided, there is a problem that it is difficult to perform the operation of removing the sheet in a case where the shutter is secured in a state of sandwiching a sheet jammed in an image forming apparatus body. On the other hand, when the lock member is not provided, an operator may inadvertently move the shutter.

### SUMMARY

The present disclosure described herein provides an image forming apparatus that includes an apparatus body, a transfer unit, a fixing unit, an attachment member, a guide member, and a shutter. The transfer unit transfers a toner image to a sheet. The fixing unit fixes the toner image on the sheet. The attachment member is detachably attached to the apparatus body. The guide member includes a guide surface to guide the sheet conveyed from the transfer unit to the fixing unit. The shutter switches between a closed state in which the shutter approaches the guide member and enters a sheet conveyance path between the transfer unit and the fixing unit, and an open state in which the shutter is farther from the guide member than in the closed state and retracted from the sheet conveyance path. The shutter switches to the open state in conjunction with an attachment operation of the attachment member to the apparatus body, and switches to the closed state in conjunction with a detachment operation of the attachment member from the apparatus body. The guide surface includes an upstream guide surface upstream from the shutter and downstream from the transfer unit in a sheet conveyance direction. When the shutter is in the closed state, a first end of the shutter closer to the guide surface than a second end opposite the first end is placed at a portion recessed from a downstream end of the upstream guide surface in the sheet conveyance direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an entire configuration of an image forming apparatus according to a first embodiment;

FIG. 2 is a side view illustrating a configuration and an operation of a shutter according to the first embodiment;

FIG. 3 is a side view illustrating the configuration and the operation of the shutter according to the first embodiment;

FIG. 4 is a perspective view illustrating a configuration of a shutter guide mechanism according to the first embodiment;

FIG. 5 is a perspective view illustrating another configuration of the shutter guide mechanism according to the first embodiment;

FIG. 6 is a diagram illustrating an operation of the shutter when removing a sheet jammed in an apparatus body in the first embodiment;

FIG. 7 is a diagram illustrating a positional relationship between a distal end of the shutter and a downstream end of an upstream guide surface according to the first embodiment;

FIG. 8 is a diagram illustrating a positional relationship between an actuation projection of the shutter and a sheet conveyance region according to the first embodiment;

FIG. 9 is a diagram illustrating an example of a positional relationship between a load generated by contact between the actuation projection and a shutter operating part and a positioner of an image forming unit when the shutter according to the first embodiment is in an open state;

FIG. 10 is a diagram illustrating a vertical line at a contact point between the actuation projection and the shutter operating part;

FIG. 11 is a diagram illustrating another positional relationship between the load generated by the contact between the actuation projection and the shutter operating part and the positioner of the image forming unit when the shutter according to the first embodiment is in the open state;

FIG. 12 is a side view illustrating a configuration and an operation of a shutter according to a second embodiment;

FIG. 13 is a side view illustrating the configuration and the operation of the shutter according to the second embodiment;

FIG. 14 is a diagram illustrating a configuration of a rotation restrictor according to the second embodiment;

FIG. 15 is a diagram illustrating an operation of the shutter when removing a sheet jammed in an apparatus body in the second embodiment;

FIG. 16 is a side view illustrating a configuration and an operation of a shutter according to a third embodiment;

FIG. 17 is a side view illustrating the configuration and the operation of the shutter according to the third embodiment;

FIG. 18 is a side view illustrating a configuration and an operation of a shutter according to a fourth embodiment;

FIG. 19 is a side view illustrating the configuration and the operation of the shutter according to the fourth embodiment;

FIG. 20 is a front view of a wall according to the fourth embodiment as viewed in a direction of a transfer unit;

FIG. 21 is a diagram illustrating an example in which a wall is provided in a configuration in which the shutter moves in a vertical direction;

FIG. 22 is a side view illustrating a configuration and an operation of a shutter according to a fifth embodiment;

FIG. 23 is a side view illustrating the configuration and the operation of the shutter according to the fifth embodiment;

FIG. 24 is a plan view illustrating a configuration of a partition wall according to the fifth embodiment;

FIG. 25 is a diagram illustrating a modification of a shutter;

FIG. 26 is a diagram illustrating an operation of the shutter of FIG. 25 when removing a sheet jammed in an apparatus body;

FIG. 27 is a diagram illustrating a modification of a guide member and an operation of a shutter; and

FIG. 28 is a diagram illustrating an operation of the shutter of FIG. 27.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings attached, descriptions are given below of embodiments of the present disclosure. In the drawings for illustrating embodiments of the present disclosure, like reference signs are assigned to elements such as components and parts that have a like function or a like shape as far as distinguishable, and descriptions of such elements may be omitted once the description is provided.

### Overall Configuration of Image Forming Apparatus

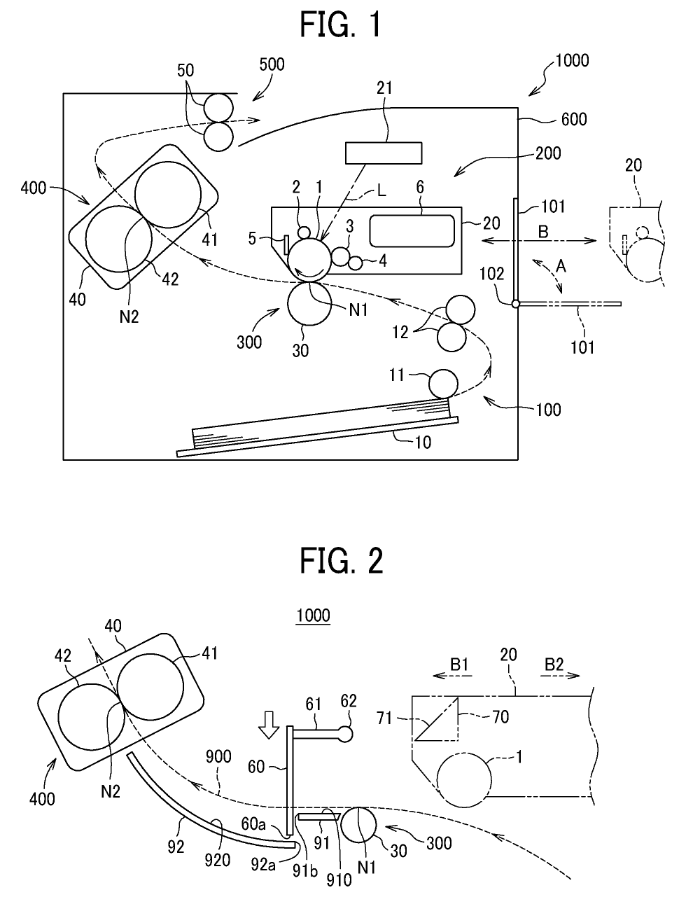

First, an overall configuration of an image forming apparatus according to a first embodiment of the present disclosure will be described with reference to FIG. 1. In the following description, the term "image forming apparatus" includes a printer, a copier, a facsimile machine, a printing machine, or a multifunction peripheral including a combination of at least two of the printer, the copier, the facsimile machine, and the printing machine. The term "image formation" used in the following description includes the formation of images with meanings such as characters and figures and the formation of images with no meanings such as patterns.

FIG. 1 is a schematic diagram illustrating an entire configuration of an image forming apparatus 1000 according to a first embodiment of the present disclosure.

As illustrated in FIG. 1, the image forming apparatus 1000 according to the first embodiment includes a sheet supply unit 100, an image forming unit 200, a transfer unit 300, a fixing unit 400, and a sheet ejection unit 500.

The sheet supply unit 100 is provided with a placement tray 10 on which a sheet S as a recording medium on which an image is formed is placed, a feeding roller 11 that feeds the sheet S from the placement tray 10, and the like. The sheet S placed on the placement tray 10 may be paper such as plain paper, cardboard, a postcard, an envelope, thin paper, coated paper, or tracing paper, an overhead projector (OHP) sheet or fabric, a metal sheet, a plastic film, a prepreg sheet in which carbon fibers are impregnated with a resin in advance, or the like.

The image forming unit 200 is provided with an image forming unit 20 detachably attached to an apparatus body (image forming apparatus body) 600, an exposure device 21, and the like. The image forming unit 20 is an attachment member (attachment unit) integrally including a photoconductor 1, a charging member 2, a developing member 3, a supply member 4, a cleaning member 5, a toner storage 6, and the like. Note that the image forming unit 20 is not limited to one that integrally includes these components, and a unit including the photoconductor 1 and the developing member 3 and a unit including the toner storage 6 may be separate units, or a unit including the photoconductor 1 and a unit including the developing member 3 and the toner storage 6 may be separate units.

The transfer unit 300 is provided with, for example, a transfer roller 30 as a transfer member. In this case, the transfer roller 30 is in contact with the surface of the photoconductor 1 to form a transfer nip N1 between the transfer roller 30 and the photoconductor 1. Note that the transfer member is not limited to a roller-shaped member, and may be an endless belt member or the like.

The fixing unit 400 is provided with a fixing device 40 including a heating roller 41 heated by a heating source such as a heater, a pressure roller 42 pressed against the heating roller 41, and the like. The heating roller 41 and the pressure roller 42 are pressed against each other to form a fixing nip N2. The member forming the fixing nip N2 is not limited to a roller-shaped member such as the heating roller 41 and the pressure roller 42, and may be an endless belt member in which a nip forming member such as a pad is provided inside.

The sheet ejection unit 500 is provided with, for example, a pair of ejection rollers 50 which eject sheets to the outside of the apparatus.

### Basic Operations of Image Forming Apparatus

Next, basic operations of the image forming apparatus 1000 according to the first embodiment will be described with reference to FIG. 1.

When there is an instruction to start image formation, first, the sheet S is fed from the sheet supply unit 100. The fed sheet S abuts against a pair of timing rollers 12 while being conveyed to the transfer nip N1. As a result, the conveyance of the sheet S is temporarily stopped, and the skew feeding of the sheet S is corrected.

In addition, when there is an instruction to start image formation, the photoconductor 1 starts rotation, and then, the surface of the photoconductor 1 is charged by the charging member 2 so as to have a uniform high potential. Then, the exposure device 21 irradiates the surface (charged surface) of the photoconductor 1 with a laser light L to expose the surface, and thus, the potential of the exposed portion decreases and a latent image (electrostatic latent image) is formed on the surface of the photoconductor 1. The latent image is formed on the basis of image information of a document read by a document reading device or image information instructed to be printed by an external terminal. Thereafter, toner is supplied from the developing member 3 to the latent image on the photoconductor 1, and thus, the latent image is developed as a toner image. After the toner supply, the toner in the toner storage 6 is supplied to the developing member 3 by the supply member 4.

Thereafter, when the timing roller 12 starts rotating, the sheet S is conveyed to the transfer nip N1 in synchronization with the toner image on the photoconductor 1. At this time, a transfer bias having a polarity opposite to the charging polarity of the toner is applied to the transfer roller 30, and the toner image is electrostatically transferred from the photoconductor 1 to the sheet S by the action of the transfer bias. After the toner image is transferred, the surface of the photoconductor 1 is cleaned by the cleaning member 5, and foreign matter such as residual toner is removed from the surface of the photoconductor 1.

Thereafter, the sheet S is conveyed to the fixing device 40, and enters the fixing nip N2 between the heating roller 41 and the pressure roller 42. As a result, the toner image on the sheet S is heated and pressurized, and the toner image is fixed to the sheet S. Thereafter, the sheet S is ejected to the outside of the apparatus by the ejection rollers 50, and a series of image forming operations ends.

### Attachment/Detachment Operation of Image Forming Unit

Next, an attachment/detachment operation of the image forming unit 20 according to the first embodiment will be described with reference to FIG. 1.

As illustrated in FIG. 1, in the first embodiment, the apparatus body 600 of the image forming apparatus 1000 has an openable and closable door 101. In this case, the door 101 is configured to be openable and closable by rotating in a direction of an arrow A in FIG. 1 around a support shaft 102 disposed in the apparatus body 600.

When the door 101 is in an open state indicated by a two-dot chain line in FIG. 1, the image forming unit 20 is in a state of being detachable in a direction of an arrow B in FIG. 1 through an opening of the opened apparatus body 600. When maintenance work of the image forming unit 20 or removal work of a sheet jammed in the apparatus body (image forming apparatus body) 600 is performed, the maintenance work or the sheet removal work can be performed by opening the door 101 and taking out the image forming unit 20 from the image forming apparatus body 600.

Here, when the image forming unit 20 is detached from the apparatus body 600, the image forming unit 20 is not in the apparatus body 600, and thus, the fixing device 40 can be accessed from the opening of the apparatus body 600 via an attachment/detachment path of the image forming unit 20 and a sheet conveyance path on the back side of the attachment/detachment path. Therefore, in the first embodiment, a shutter that prevents access to the fixing device 40 when the image forming unit 20 is detached is provided.

Hereinafter, the configuration and operation of the shutter according to the first embodiment will be described.

### Configuration of Shutter

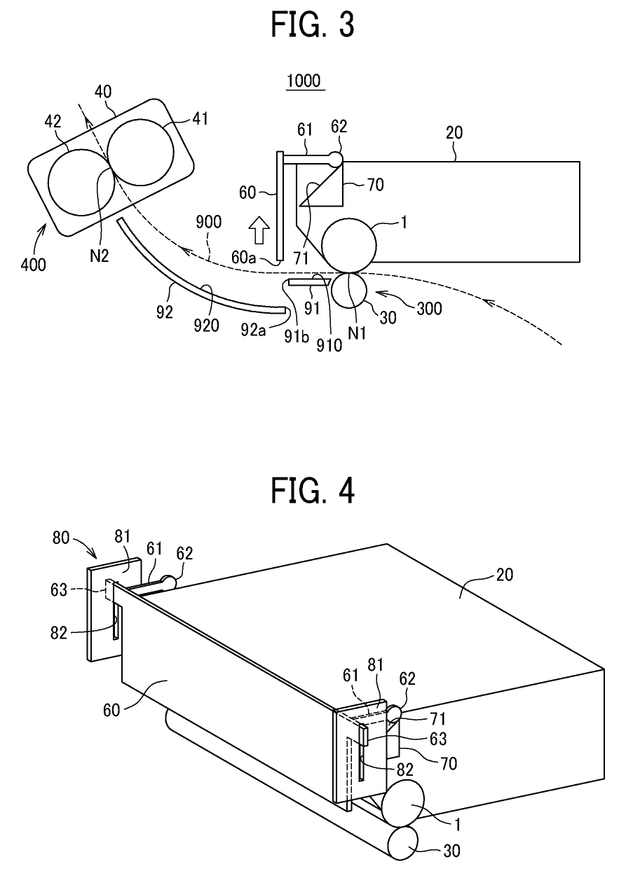

FIGS. 2 and 3 are side views illustrating a configuration and an operation of a shutter 60 according to the first embodiment. In particular, FIG. 2 illustrates a state in which the image forming unit 20 is detached from the apparatus body 600, and FIG. 3 illustrates a state in which the image forming unit 20 is attached to the apparatus body 600. In FIG. 2, a two-dot chain line indicates the image forming unit 20 in the middle of attachment or detachment.

As illustrated in FIGS. 2 and 3, the shutter 60 according to the first embodiment is disposed between the transfer unit 300 (transfer nip N1) and the fixing unit 400 (fixing nip N2). In other words, the shutter 60 is disposed downstream from the transfer unit 300 in the sheet conveyance direction and upstream from the fixing unit 400 in the sheet conveyance direction. In addition, the shutter 60 is configured to move straight back and forth in the vertical direction in FIGS. 2 and 3. Therefore, the shutter 60 is configured to be switchable between a closed state in which the shutter 60 moves downward and enters a sheet conveyance path 900 as illustrated in FIG. 2 and an open state in which the shutter 60 moves upward and is placed at a position retracted from the sheet conveyance path 900 as compared with the closed state as illustrated in FIG. 3.

In addition, the shutter 60 is configured to be switchable between the closed state and the open state in conjunction with the attachment/detachment operation of the image forming unit 20 with respect to the apparatus body 600. Specifically, the shutter 60 includes an actuation projection 61 that can come into contact with a shutter operating part 70 of the image forming unit 20. The actuation projection 61 has a circular contact portion 62 that can come into contact with the shutter operating part 70 at a distal end of the actuation projection 61. On the other hand, the shutter operating part 70 has an inclined surface portion 71 that can come into contact with the contact portion 62 of the actuation projection 61. The inclined surface portion 71 is disposed so as to be inclined with respect to an attachment direction B1 or a detachment direction B2 (see FIG. 2) of the image forming unit 20 with respect to the apparatus body 600. More specifically, the inclined surface portion 71 is disposed so as to face the attachment direction B1 of the image forming unit 20 and face the moving direction (upper side in FIG. 2) in which the shutter 60 is brought into the open state.

Since the shutter operating part 70 having the inclined surface portion 71 is provided in the image forming unit 20, when the image forming unit 20 is inserted in the direction of the arrow B1 (attachment direction) from the state of FIG. 2, the inclined surface portion 71 comes into contact with the distal end (contact portion 62) of the actuation projection 61 of the shutter 60. Then, when the image forming unit 20 is further inserted, the actuation projection 61 is pushed up along the inclined surface portion 71, and thus, the shutter 60 moves upward as illustrated in FIG. 3 and is switched to the open state. In this state, the shutter 60 is placed at a position more retracted from the sheet conveyance path 900 than in the closed state of FIG. 2, and thus sheet conveyance is allowed.

Note that, here, the sheet conveyance path 900 is indicated by a dotted line for convenience, but actually, the sheet is conveyed with a certain degree of variation, and thus, the sheet conveyance path 900 is also in a range having a certain degree of width. Therefore, the shutter 60 in the open state is placed so as to retract from the conveyance space (sheet conveyance path 900) in which the sheet is conveyed with a certain degree of variation.

On the other hand, when the image forming unit 20 is moved in the direction of the arrow B2 (detachment direction) in FIG. 2, the push-up by the shutter operating part 70 is gradually released along with the movement of the image forming unit 20, and thus, the shutter 60 moves downward by its self-weight and is switched to the closed state illustrated in FIG. 2. In this closed state, the shutter 60 enters the sheet conveyance path 900, and the shutter 60 is placed to cover the fixing device 40 on the upstream side from the fixing device 40 in the sheet conveyance direction, and thus, the fixing device 40 cannot be accessed from the opening of the apparatus body 600.

FIG. 4 is a perspective view illustrating a configuration of a shutter guide mechanism 80 that guides the shutter 60 according to the first embodiment.

As illustrated in FIG. 4, the shutter guide mechanism 80 includes a pair of guide plates 81 secured to the apparatus body (image forming apparatus body) 600. The pair of guide plates 81 are disposed on both end sides in the width direction of the shutter 60 and has guide grooves 82 respectively extending in the moving direction of the shutter 60 (switching direction between the closed state and the open state). On the other hand, the shutter 60 has a pair of projecting pieces 63 to be inserted into each of the guide grooves 82. As the pair of projecting pieces 63 moves along each of the guide grooves 82, the shutter 60 is switched between the closed state and the open state.

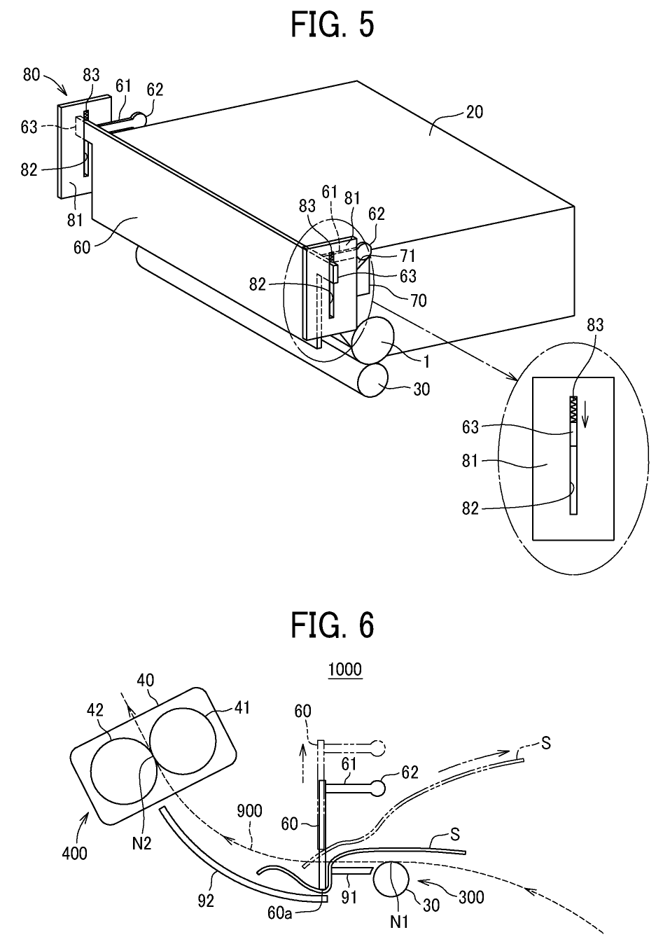

Further, as in the example of FIG. 5, the shutter guide mechanism 80 may include a spring 83 as a biasing member that biases the projecting pieces 63 of the shutter 60 in the guide grooves 82. In this case, since the shutter 60 is biased in the direction in which the shutter 60 is switched to the closed state by the spring 83, the shutter 60 can be more reliably moved to the position of the closed state, and the closed state after the movement can be more reliably maintained.

As described above, in the first embodiment, when the image forming unit 20 is installed to the apparatus body 600, the shutter 60 is switched to the open state in conjunction with the attachment operation of the image forming unit 20, and thus, when the image forming unit 20 is attached, there is no problem that the sheet cannot be conveyed due to forgetting the switching operation of the shutter 60, or the like. In addition, when the image forming unit 20 is detached from the apparatus body 600, the shutter 60 is switched to the closed state in conjunction with the detachment operation of the image forming unit 20, and thus, access to the fixing device 40 can be prevented.

However, in the configuration of the first embodiment, the lock mechanism for securing the shutter 60 in the closed state is not provided, and thus, the shutter 60 can be moved even when the shutter 60 is in the closed state. Therefore, when the operator inadvertently moves the shutter 60 during the sheet removal work or the like, the hand of the operator may touch the fixing device 40. Therefore, in the first embodiment, the following configuration is adopted in order to prevent the operator from inadvertently moving the shutter in the closed state. Hereinafter, a configuration for preventing inadvertent operation of the shutter 60 will be described.

### Configuration for Preventing Inadvertent Operation of Shutter

As illustrated in FIG. 2, in the first embodiment, an upstream guide member 91 and a downstream guide member 92 that guide a sheet are provided between the transfer unit 300 and the fixing unit 400. The upstream guide member 91 is disposed upstream from the shutter 60 in the sheet conveyance direction, and the downstream guide member 92 is provided downstream from the upstream guide member 91 in the sheet conveyance direction. In addition, these guide members 91 and 92 have guide surfaces 910 and 920 that are in contact with the sheet and guide the sheet on a surface facing the sheet conveyance path 900.

Here, in the first embodiment, the guide surface 910 of the upstream guide member 91 and the guide surface 920 of the downstream guide member 92 are arranged to form a step with a boundary therebetween. Specifically, an upstream end 92a of the guide surface 920 (hereinafter, referred to as "upstream end 92a of the downstream guide surface 920”) of the downstream guide member 92 in the sheet conveyance direction is disposed at a position (lower portion in FIG. 2) lower than a downstream end 91b of the guide surface 910 (hereinafter, referred to as "downstream end 91b of the upstream guide surface 910") of the upstream guide member 91 in the sheet conveyance direction, and thus, a step is formed between the upstream guide surface 910 and the downstream guide surface 920.

Then, with respect to the guide surfaces 910 and 920 on which such a step is formed, the shutter 60 is disposed such that an end 60a (hereinafter, referred to as "distal end 60a") of the shutter 60 on a side close to the downstream guide surface 920 is placed at a portion recessed in a step shape between the guide surfaces 910 and 920 when the shutter 60 is in the closed state in FIG. 2.

As described above, in the first embodiment, when the shutter 60 is in the closed state, the distal end 60a of the shutter 60 is placed so as to be located at a recessed portion between the guide surfaces 910 and 920, and thus, it is difficult for the operator to move the shutter 60. That is, as illustrated in FIG. 2, in the state in which the shutter 60 is switched to the closed state, the distal end 60a of the shutter 60 is placed at a portion recessed from the downstream end 91b of the upstream guide surface 910, and thus, the distal end 60a of the shutter 60 is less likely to be seen from the opening side (right side in FIG. 2) of the apparatus body 600, and a finger is less likely to reach the distal end 60a of the shutter 60. This makes it difficult for the operator to move the shutter 60 in the closed state, and thus, the operator can be prevented from inadvertently moving the shutter 60 during the sheet removal work or the like.

In addition, according to the configuration according to the first embodiment, it is possible to prevent inadvertent operation of the shutter 60 by the operator without providing the lock mechanism for securing the shutter 60, and thus, it is easy to perform the operation of removing the jammed sheet. That is, as illustrated in FIG. 6, even in a state where the sheet S jammed in the apparatus body 600 is sandwiched by the distal end 60a of the shutter 60 in the closed state, the shutter 60 is not locked. Therefore, as illustrated by the two-dot chain line in FIG. 6, the shutter 60 can be moved by pulling the sheet S from the opening side (right side in FIG. 6) of the apparatus body 600, and thus, the sandwiching of the sheet S can be released. As described above, according to the configuration of the first embodiment, the efficiency of the sheet removal work can be improved, and the possibility that the sheet S is torn during the removal operation and remains in the apparatus body 600 can be reduced, and thus, the workability of removing the sheet S is improved. In order to make it easy to move the shutter 60 by the force when the sheet S is pulled, it is preferable that the self-weight of the shutter 60 or the biasing force by a spring or the like for maintaining the closed state of the shutter 60 is 1 N or less.

As described above, according to the configuration of the first embodiment, even when the lock mechanism for securing the shutter 60 in the closed state is not provided, it is possible to make it difficult for the operator to inadvertently move the shutter 60 in the closed state, and thus, safety is improved. In addition, since the lock mechanism for securing the shutter 60 in the closed state is not provided, even when the jammed sheet S is sandwiched by the distal end 60a of the shutter 60, the sheet S can be pulled to move the shutter 60, and thus, the workability of removing the sheet S is improved. As described above, according to the configuration of the first embodiment, it is possible to achieve both ensuring of safety and improvement of sheet removal workability.

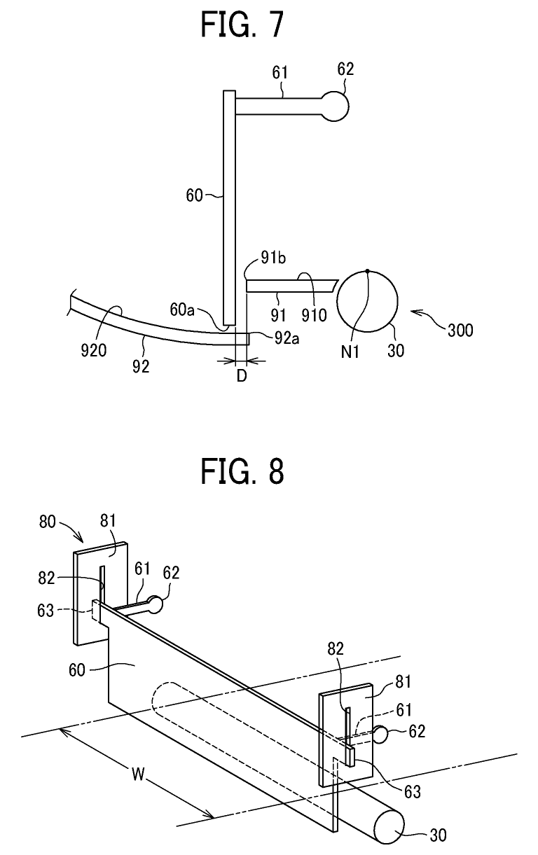

In addition, the position of the distal end 60a of the shutter 60 in the closed state may be a position recessed from the downstream end 91b of the upstream guide surface 910. However, in order to more reliably prevent inadvertent operation (movement) of the shutter 60, it is preferable that the distal end 60a (specifically, at least an upstream end of the distal end 60a in the sheet conveyance direction) of the shutter 60 in the closed state is placed downstream from the downstream end 91b of the upstream guide surface 910 in the sheet conveyance direction at a distance D within 5 mm as illustrated in FIG. 7. As described above, since the distal end 60a of the shutter 60 is placed at the distance D within 5 mm downstream from the downstream end 91b of the upstream guide surface 910 in the sheet conveyance direction, the gap between the upstream guide surface 910 and the shutter 60 can be reduced (to 5 mm or less), and thus, it becomes more difficult for the operator to touch the distal end 60a of the shutter 60, and the inadvertent operation (movement) of the shutter 60 can be more reliably prevented.

Further, in the closed state, the distal end 60a of the shutter 60 may come into contact with the downstream guide surface 920 at the recessed position. However, when the downstream guide surface 920 is damaged by the contact of the shutter 60, sheet conveyance failure and sheet jam may occur due to the damage. Therefore, as illustrated in FIG. 7, it is preferable that the distal end 60a of the shutter 60 in the closed state is placed in a non-contact manner with the downstream guide surface 920.

As illustrated in FIG. 8, it is preferable that the actuation projection 61 and the contact portion 62 provided on the shutter 60 are disposed in a region outside a sheet conveyance region W where the sheet is conveyed. Here, the sheet conveyance region W is illustrated in a planar shape, but the "sheet conveyance region W" here refers to the entire region where the sheet can be conveyed, and refers to a region including not only a planar region (region indicated by a two-dot chain line) illustrated in FIG. 8 but also a space in a direction orthogonal to the planar region. In addition, in a case where a plurality of types of sheets having different width sizes can be conveyed, it is preferable that the actuation projection 61 and the contact portion 62 are disposed outside a sheet conveyance region (maximum sheet conveyance region) in which a sheet having the maximum width size among the sheets is conveyed. As described above, since the actuation projection 61 and the contact portion 62 are disposed outside the sheet conveyance region W, it is difficult for the operator to touch the actuation projection 61 and the contact portion 62 through the sheet conveyance path 900, and thus, it is possible to more reliably prevent inadvertent operation (movement) of the shutter 60 due to the touch of the operator. In addition, the arrangement of the actuation projection 61 and the contact portion 62 (the arrangement outside the sheet conveyance region W) is only required to be satisfied at least when the shutter 60 is in the closed state.

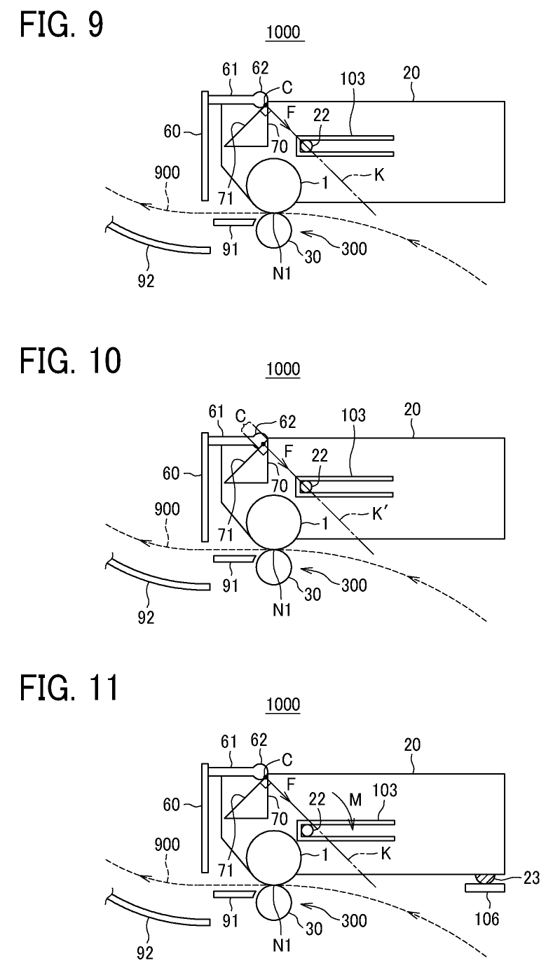

FIG. 9 is a diagram illustrating an example of a positional relationship between a load F generated by the contact between the actuation projection 61 (contact portion 62) and the shutter operating part 70 (inclined surface portion 71) and a positioner (first positioner) 22 of the image forming unit 20 when the shutter 60 is in the open state in the first embodiment.

In this case, the image forming unit 20 includes the first positioner 22 that is positioned with respect to the apparatus body 600 when the image forming unit 20 is attached to the apparatus body 600. The first positioner 22 is, for example, a boss protruding from an outer wall surface of the image forming unit 20. The first positioner 22 abuts on the end along a guide rail 103 provided in the apparatus body 600, and thus, the image forming unit 20 is positioned by the first positioner 22. The image forming unit 20 also includes a second positioner serving as a sub-reference for restricting rotation around the first positioner 22 as a rotation axis. Therefore, after the first positioner 22 serving as the main reference is positioned, the image forming unit 20 is positioned with respect to the apparatus body 600 through performing positioning in the rotation direction with the main reference as the rotation axis by the second positioner serving as the sub-reference.

Here, as illustrated in FIG. 9, when the image forming unit 20 is installed, the shutter 60 is switched to the open state, and thus, at a contact point C between the actuation projection 61 (contact portion 62) and the shutter operating part 70 (inclined surface portion 71), the load F due to the self-weight of the shutter 60 acts in a direction perpendicular to the inclined surface portion 71 which is the contact surface. Since the load F due to the self-weight of the shutter 60 constantly acts on the image forming unit 20 while the shutter 60 is in the open state, the load F may affect the positioning of the image forming unit 20.

Therefore, in a case where the positioning of the image forming unit 20 is not desired to be affected by the load F, as illustrated in FIG. 9, it is preferable that when viewed in the axial direction with the first positioner 22 (main reference) as the rotation axis, the first positioner 22 is placed on a vertical line K extending perpendicularly to the inclined surface portion 71 from the contact point C between the contact portion 62 and the inclined surface portion 71. As a result, since no rotational moment is generated with the first positioner 22 as the rotation axis, it is possible to prevent positional shift due to rotation of the image forming unit 20 under the influence of the load F.

In addition, as in the example of FIG. 10, the contact point C between the contact portion 62 and the inclined surface portion 71 may be a range having a certain width (range of reference sign C). However, in this case, unlike the example of FIG. 9 in which the point of action of the load F is one point, the load F acts in a wide range, and thus it is necessary to determine how to set the start point of the vertical line K based on the point of action of the load F. Therefore, in the example of FIG. 10, the first positioner 22 is placed on a vertical line K′ extending perpendicularly to the inclined surface portion 71 from the central position of the contact point C. In this manner, by arranging the first positioner 22 on the vertical line K′ extending perpendicularly to the inclined surface portion 71 from the central position of the contact point C, it is possible to prevent the generation of the rotational moment with the first positioner 22 as the rotation axis, and thus, it is possible to prevent the positional shift of the image forming unit 20 in the rotation direction.

Note that, as in the example of FIG. 10, the contact portion 62 may have a triangular shape or the like. However, since the contact resistance can be reduced as the contact area with the inclined surface portion 71 is smaller, it is preferable that the contact portion 62 has a linear contact or point contact shape such as a circle or a sphere as illustrated in FIG. 9 in order to smoothly perform the opening/closing operation of the shutter 60.

FIG. 11 is a diagram illustrating another positional relationship between the load F generated by the contact between the actuation projection 61 (contact portion 62) and the shutter operating part 70 (inclined surface portion 71) and the positioner (first positioner) 22 of the image forming unit 20 when the shutter 60 is in the open state.

In the example of FIG. 11, the first positioner 22 of the image forming unit 20 is placed at a position closer to the transfer unit 300 than the vertical line K extending perpendicularly to the inclined surface portion 71 from the contact point C between the contact portion 62 in the open state and the inclined surface portion 71 when viewed in the axial direction with the first positioner 22 as the rotation axis. Except for this point, the example of FIG. 11 is the same as the example of FIG. 9.

In this case, since the direction (vertical line K) of the load F generated at the contact point C passes through a position farther from the transfer unit 300 than the first positioner 22, a clockwise rotational moment M about the first positioner 22 is generated in FIG. 11. In this case, the image forming unit 20 receives such a force that the rear end side (the side opposite to the attachment direction) is biased downward in FIG. 11 by the rotational moment M. Therefore, in the example of FIG. 11, a second positioner 23 serving as the sub-reference is provided on a rear end side of the image forming unit 20, and a contact portion 106 that receives the second positioner (sub-reference) 23 from below is provided in the apparatus body 600, and thus, the image forming unit 20 can be positioned in the rotation direction. Moreover, in this case, while the shutter 60 is in the open state, the second positioner 23 serving as the sub-reference is positioned and held in a state of being biased with respect to the contact portion 106 of the apparatus body 600 by the rotational moment M that is constantly generated, and thus, the contact state between the second positioner (sub-reference) 23 and the contact portion 106 can be more reliably maintained, and more stable positioning can be ensured. As described above, the rotational moment M generated when the shutter 60 is in the open state may be used as the biasing force for positioning the image forming unit 20.

Note that, also in the example of FIG. 11, the contact portion 62 and the inclined surface portion 71 may be in contact with each other in a range having a certain width as illustrated in FIG. 10. In this case, in order to generate the rotational moment M as illustrated in FIG. 11, the first positioner 22 is only required to be placed at a position closer to the transfer unit 300 than the vertical line K′ (see FIG. 10) extending perpendicularly to the inclined surface portion 71 from the central position of the contact point C.

Other embodiments of the present disclosure are described below. In the following description, portions different from those of the first embodiment will be mainly described, and description of the same portions will be omitted as appropriate.

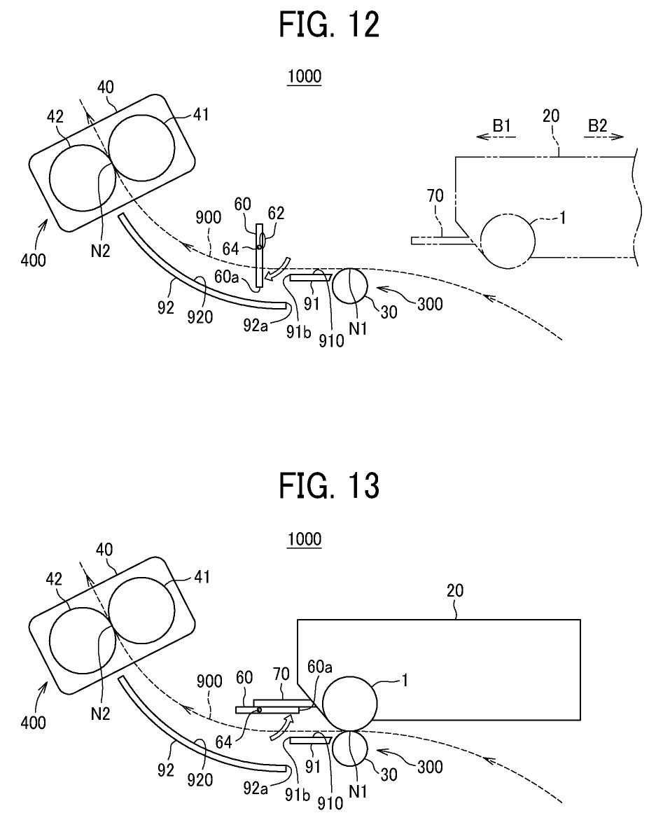

FIGS. 12 and 13 are side views illustrating the configuration and the operation of the shutter 60 according to a second embodiment of the present disclosure.

In the second embodiment illustrated in FIGS. 12 and 13, the shutter 60 is configured to be rotatable about a support shaft 64. On the other hand, the image forming unit 20 includes the shutter operating part 70 that comes into contact with the contact portion 62 of the shutter 60 (a portion above the support shaft 64 surrounded by a round frame in FIG. 12) to switch the shutter 60 from the closed state to the open state. In this case, the shutter operating part 70 includes a projection protruding from the image forming unit 20 in the attachment direction B1 (see FIG. 12).

In the second embodiment configured as described above, when the image forming unit 20 is inserted into the apparatus body 600 from the state of FIG. 12, the shutter operating part 70 comes into contact with the contact portion 62 of the shutter 60, and thus, the shutter 60 is pushed and moved to rotate in the arrow direction of FIG. 13 around the support shaft 64 as illustrated in FIG. 13, and is switched to the open state of being retracted from the sheet conveyance path 900.

On the other hand, when the image forming unit 20 is moved in the detachment direction from the state of FIG. 13, the contact between the shutter 60 (contact portion 62) and the shutter operating part 70 is released by the movement of the image forming unit 20, and thus, the shutter 60 rotates in the arrow direction in FIG. 12 by its self-weight. As a result, the shutter 60 enters the sheet conveyance path 900, and is switched to the closed state of shielding the sheet conveyance path 900 between the transfer unit 300 and the fixing unit 400.

As described above, in the second embodiment, the image forming unit 20 includes the shutter operating part 70 that rotates the shutter 60, and thus, the shutter 60 can be switched between the closed state and the open state in conjunction with the attachment/detachment operation of the image forming unit 20.

In addition, in the second embodiment, when the shutter 60 is in the closed state of FIG. 12, as in the first embodiment, the distal end 60a of the shutter 60 is placed at a portion recessed from the downstream end 91b of the upstream guide surface 910, and thus, the operator is less likely to touch the distal end 60a of the shutter 60, and inadvertent operation (rotation) of the shutter 60 can be prevented.

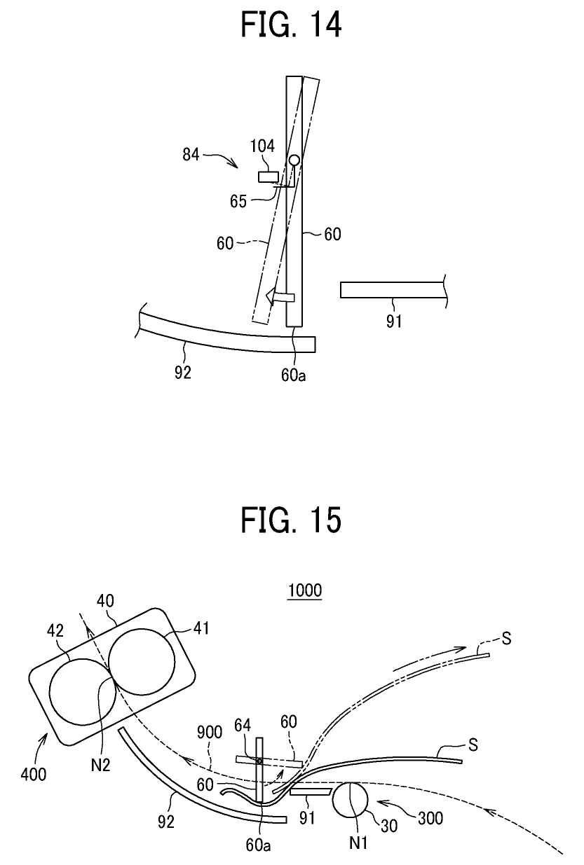

Furthermore, in the second embodiment, as illustrated in FIG. 14, a rotation restrictor 84 that restricts the rotation of the shutter 60 in the closed state is provided. In this case, the rotation restrictor 84 includes a projection 65 provided on the shutter 60 and a stopper 104 provided on the apparatus body 600. The projection 65 is provided to protrude to the downstream side in the sheet conveyance direction with respect to the shutter 60. The stopper 104 is provided on the distal end 60a side of the support shaft 64 of the shutter 60 and downstream from the shutter 60 in the sheet conveyance direction. When the shutter 60 rotates in the clockwise direction from the closed state indicated by a solid line in FIG. 14, the projection 65 comes into contact with the stopper 104, and thus, the rotation of the shutter 60 is restricted. Therefore, even when the portion on the distal end 60a side of the shutter 60 (the portion below the support shaft 64 in FIG. 14) is pushed and moved toward the downstream side in the sheet conveyance direction by the operator, the projection 65 comes into contact with the stopper 104, and thus, further rotation of the shutter 60 is restricted. As described above, the rotation of the shutter 60 in the closed state in the direction opposite to the rotation direction to the open state (the clockwise direction in FIG. 14) is restricted by the rotation restrictor 84, and thus, it is possible to more reliably prevent inadvertent operation (rotation) of the shutter 60.

On the other hand, also in the second embodiment, the rotation of the shutter 60 from the closed state to the open state is allowed. Therefore, as indicated by a solid line in FIG. 15, even when the sheet S jammed in the apparatus body 600 is sandwiched by the distal end 60a of the shutter 60, the sheet S can be removed by rotating the shutter 60 (in the direction of the open state) by pulling the sheet S as indicated by a two-dot chain line in the drawing. Note that, also in this case, in order to prevent inadvertent operation (rotation) of the shutter 60, a biasing member that biases the shutter 60 to the closed state may be provided. In this case, in order to facilitate the work of removing the sheet S, it is preferable that the biasing force for maintaining the closed state of the shutter 60 is 1 N or less.

As described above, also in the second embodiment, it is possible to prevent inadvertent operation (rotation) of the shutter 60 even without providing the lock mechanism that secures the shutter 60 in the closed state, and thus, it is possible to easily perform the process of removing the jammed sheet S, and it is possible to achieve both ensuring of safety and improvement of sheet removal workability.

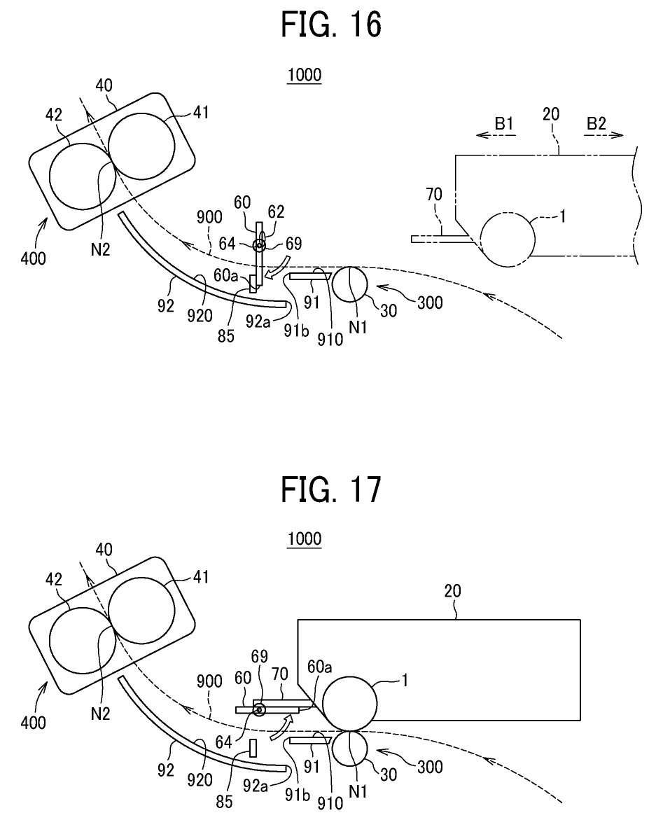

Next, FIGS. 16 and 17 illustrate the configuration and operation of the shutter 60 according to a third embodiment of the present disclosure.

In the third embodiment illustrated in FIGS. 16 and 17, as in the second embodiment, the shutter 60 is rotatable about the support shaft 64, but the third embodiment differs in that the shutter 60 is biased in a direction to become the closed state by a shutter biasing member 69. In this case, as the shutter biasing member 69, a torsion spring provided on the support shaft 64 of the shutter 60 is used. Note that the shutter biasing member 69 may be a biasing member other than a torsion spring, such as a leaf spring, as long as it can bias the shutter 60 in the direction to become the closed state.

In addition, in the third embodiment, a rotation restrictor 85 that holds the shutter 60 in the closed state against the biasing force of the shutter biasing member 69 is provided. The rotation restrictor 85 is provided on the distal end 60a side of the support shaft 64 of the shutter 60 and downstream from the shutter 60 in the sheet conveyance direction. Therefore, as illustrated in FIG. 16, when the shutter 60 is biased in the arrow direction (clockwise direction) by the shutter biasing member 69, the portion of the shutter biasing member 69 closer to the distal end 60a than the support shaft 64 comes into contact with the rotation restrictor 85, and thus, the rotation of the shutter 60 is restricted. As a result, the shutter 60 is held in the closed state.

In addition, in the third embodiment, when the image forming unit 20 is inserted into the apparatus body 600 from the state of FIG. 16, the shutter operating part 70 of the image forming unit 20 comes into contact with the contact portion 62 of the shutter 60, and thus, the shutter 60 is pushed and moved to rotate in the arrow direction of FIG. 17 against the biasing force of the shutter biasing member 69 as illustrated in FIG. 17. As a result, the shutter 60 is switched to the open state retracted from the sheet conveyance path 900. The rotation restrictor 85 is provided outside the sheet conveyance path 900 so as not to hinder conveyance of the sheet.

On the other hand, when the image forming unit 20 is moved in the detachment direction from the state of FIG. 17, the contact between the shutter 60 (the contact portion 62) and the shutter operating part 70 is released by the movement of the image forming unit 20, and thus, the shutter 60 is rotated in the arrow direction in FIG. 16 by the biasing force of the shutter biasing member 69 and comes into contact with the rotation restrictor 85. As a result, the shutter 60 enters the sheet conveyance path 900 and is switched to the closed state.

As described above, in the third embodiment, when the image forming unit 20 is detached, the shutter biasing member 69 is biased by the shutter biasing member 69 in the direction to become the closed state, and thus, it is possible to more reliably switch to the closed state as compared with the configuration in which the shutter 60 is switched to the closed state only by its self-weight. Therefore, reliability is improved. Other configurations and operational effects of the third embodiment are basically the same as those of the second embodiment, and thus the description thereof will be omitted.

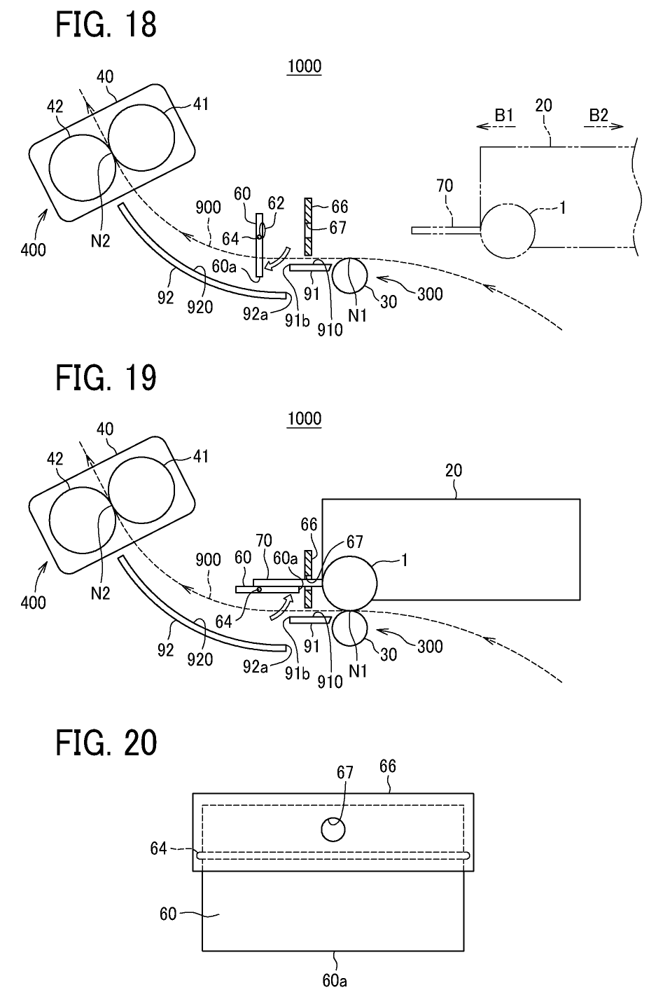

Next, FIGS. 18 and 19 illustrate the configuration and operation of the shutter 60 according to a fourth embodiment of the present disclosure.

The fourth embodiment illustrated in FIGS. 18 and 19 is obtained by adding a wall 66 covering the shutter 60 between the shutter 60 and the transfer unit 300 in the configuration of the second embodiment illustrated in FIGS. 12 and 13. The other configurations are the same as those of the second embodiment.

The wall 66 has an opening 67 into which the shutter operating part 70 can enter when the image forming unit 20 is installed to the apparatus body 600. The opening 67 is provided above the support shaft 64 of the shutter 60 in FIG. 18 or FIG. 19 (on the side opposite to the distal end 60a of the shutter 60) and at a position facing the contact portion 62 of the shutter 60. Therefore, as illustrated in FIG. 19, in the state where the image forming unit 20 is attached, the shutter operating part 70 passes through the opening 67 of the wall 66 and comes into contact with the shutter 60 (contact portion 62), and thus, the shutter 60 is pushed and moved to be switched from the closed state to the open state. The opening 67 includes, for example, a hole penetrating the wall 66.

On the other hand, as illustrated in FIG. 18, in the state where the image forming unit 20 is detached from the apparatus body 600, the shutter operating part 70 is pulled out from the opening 67 of the wall 66, and thus, the contact of the shutter operating part 70 with the shutter 60 (contact portion 62) is released, and the shutter 60 is rotated by its self-weight to be in a closed state.

As described above, in the fourth embodiment, the wall 66 covering the shutter 60 is provided between the shutter 60 and the transfer unit 300, and thus, it is difficult for the operator to touch the shutter 60. In addition, since the operator is less likely to touch the shutter 60, inadvertent operation (rotation) of the shutter 60 can be prevented. In particular, since the wall 66 is disposed to cover a portion above the support shaft 64 of the shutter 60 (that is, a portion on the side opposite to the distal end 60a across the support shaft 64, or a portion on the side opposite to the side closer to the downstream guide surface 920 of the shutter 60 than the support shaft 64), it is possible to prevent the operator from touching the upper portion of the shutter 60 and moving the shutter 60 in the direction of the open state. It is preferable that the lower end of the wall 66 (the end on the side close to the upstream guide surface 910) is located at a position lower than the support shaft 64 of the shutter 60 (the distal end 60a side of the shutter 60) so that inadvertent operation (rotation) of the shutter 60 can be more reliably prevented.

FIG. 20 is a front view of the wall 66 as viewed in the direction of the transfer unit.

As illustrated in FIG. 20, it is preferable that the wall 66 is disposed to cover the entire portion above the support shaft 64 of the shutter 60 when viewed from the transfer unit 300 side. However, the portion covered by the wall 66 excludes a portion where the opening 67 is formed. In addition, it is preferable that the size of the opening 67 is such a size that the operator cannot pass a finger.

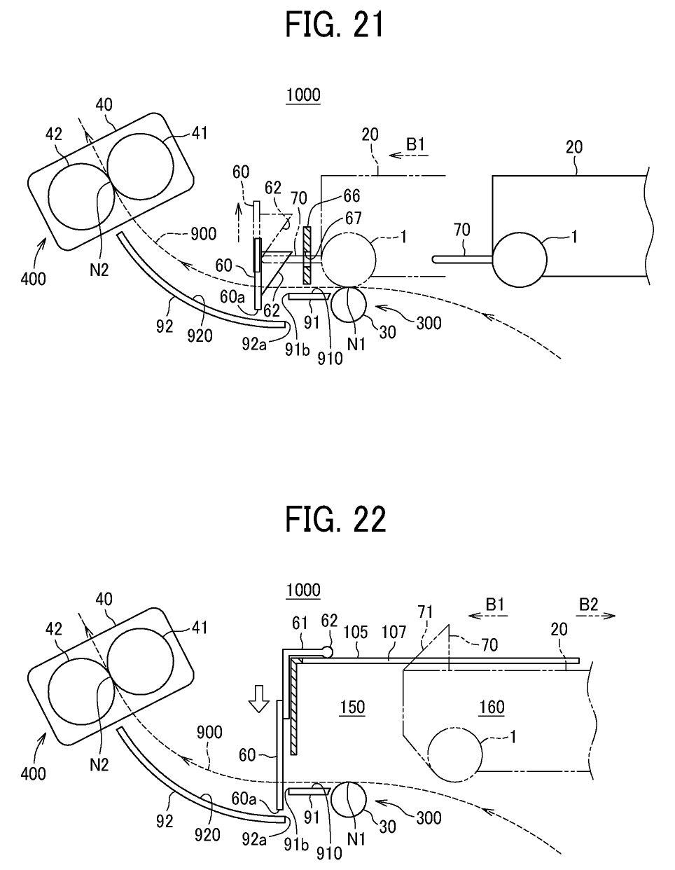

The configuration in which the wall 66 is provided is not limited to the configuration including the rotary shutter 60, and is also applicable to a configuration including the shutter 60 which moves in the vertical direction as illustrated in FIGS. 2 and 3. In this case, as illustrated in FIG. 21, a convex shutter operating part 70 may be provided in the image forming unit 20, and the contact portion 62 which is an inclined surface portion may be provided in the shutter 60. In this case, when the image forming unit 20 is installed, the shutter 60 can be moved to the open state by the convex shutter operating part 70 passing through the opening 67 of the wall 66 and coming into contact with the contact portion 62 (inclined surface portion) of the shutter 60.

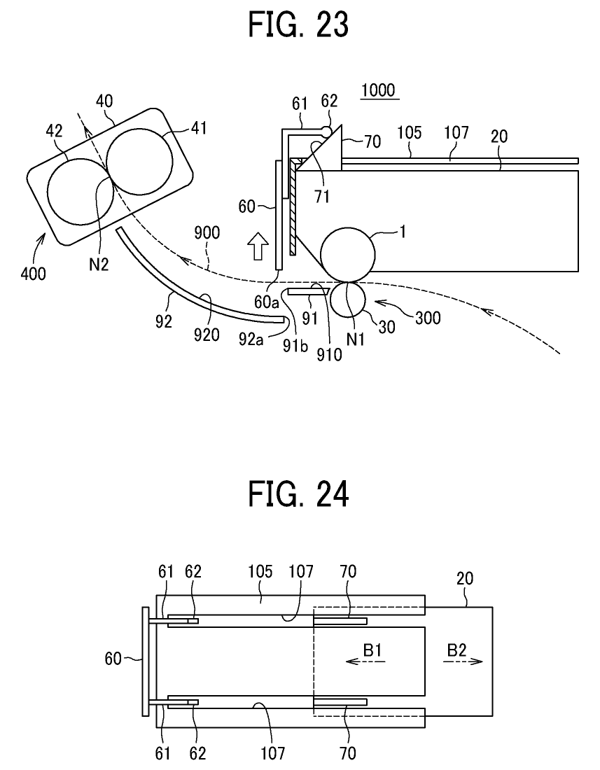

Next, FIGS. 22 and 23 illustrate the configuration and operation of the shutter 60 according to a fifth embodiment of the present disclosure.

In the fifth embodiment illustrated in FIGS. 22 and 23, both the actuation projection 61 (contact portion 62) of the shutter 60 and the shutter operating part 70 (inclined surface portion 71) of the image forming unit 20 are disposed outside an attachment space 150 (see FIG. 22) and an insertion space 160 (see FIG. 22) of the image forming unit 20. Note that the "attachment space 150 of the image forming unit 20" here refers to a space in which a portion (body) other than the shutter operating part 70 of the image forming unit 20 is placed when the image forming unit 20 is attached in the apparatus body 600, and the "insertion space 160 of the image forming unit 20" here refers to a space in the apparatus body 600 through which a portion (main body) other than the shutter operating part 70 of the image forming unit 20 passes when the image forming unit 20 is installed.

In addition, in the fifth embodiment, a partition wall 105 that defines the attachment space 150 and the insertion space 160 of the image forming unit 20 and a space outside the attachment space 150 and the insertion space 160 is provided. The actuation projection 61 (contact portion 62) and the shutter operating part 70 (inclined surface portion 71) are disposed outside the attachment space 150 and the insertion space 160 with respect to the partition wall 105.

In addition, the partition wall 105 has a slit 107 through which the shutter operating part 70 enters. As illustrated in the plan view of FIG. 24, the slit 107 is provided continuously from one end of the partition wall 105 in the attachment direction B1 of the image forming unit 20.

In this case, as illustrated in FIG. 22, when the image forming unit 20 is inserted in the attachment direction B1, the shutter operating part 70 enters the slit 107 of the partition wall 105. Then, when the shutter operating part 70 comes into contact with the actuation projection 61 that stands by ahead, the shutter 60 is pushed up by an action similar to the above-described action, and the shutter 60 is switched to the open state retracted from the sheet conveyance path 900 as illustrated in FIG. 23. On the other hand, when the image forming unit 20 is detached, the contact between the actuation projection 61 and the shutter operating part 70 is released, and thus, as illustrated in FIG. 22, the shutter 60 moves downward by its self-weight, and is switched to the closed state in which the shutter operating part 70 has entered the sheet conveyance path 900.

As described above, in the fifth embodiment, particularly, the actuation projection 61 (the contact portion 62) of the shutter 60 is disposed outside the attachment space 150 and the insertion space 160 with respect to the partition wall 105, and thus, it is difficult for the operator to notice the presence of the actuation projection 61, and it is possible to prevent inadvertent contact of the operator with the actuation projection 61. Therefore, according to the configuration according to the fifth embodiment, it is possible to more reliably prevent inadvertent operation (movement) of the shutter 60 by the operator. In addition, by setting the width of the slit 107 to such a size that the operator's finger does not pass through, it is possible to more reliably prevent the contact of the operator with the actuation projection 61.

### Modification of Shutter

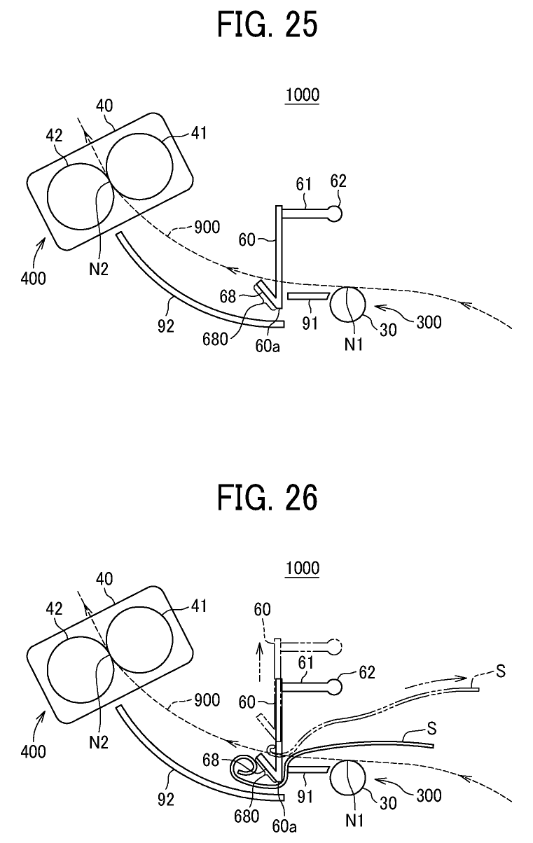

Next, FIG. 25 illustrates a modification of the shutter 60.

In the example of FIG. 25, the shutter 60 has an inclined surface 68 inclined to the transfer unit 300 side toward the distal end 60a. In other words, the shutter 60 has a bent portion 680 bent toward the downstream side in the sheet conveyance direction with the distal end 60a as a proximal end, and the bent portion 680 has the inclined surface 68 inclined to approach the guide surface of the downstream guide member 92 from the downstream side to the upstream side in the sheet conveyance direction. The other configurations are the same as those of the first embodiment.

Since the shutter 60 has the inclined surface 68, the operation of removing the jammed sheet can be easily performed. That is, as illustrated in FIG. 26, when the sheet S jammed in the apparatus body 600 is pulled, a rounded portion (jammed portion) of the sheet S is pressed against the inclined surface 68 of the shutter 60, and thus, a force in a pushing up direction acts on the inclined surface 68, so that the shutter 60 can be moved in an opening direction. In addition, when the sheet S is pulled, the sheet S is guided along the inclined surface 68, and thus, it is possible to reduce the risk of the sheet S being torn due to the sheet S being caught by the distal end 60a of the shutter 60.

Therefore, according to the shutter 60 having the inclined surface 68, the operation of removing the jammed sheet S can be more easily performed, and the workability of removing the sheet is improved. Note that, also in the modification illustrated in FIG. 25, the distal end 60a of the shutter 60, which is the end of the downstream guide member 92 on the side close to the guide surface, is placed at a portion recessed from the downstream end of the guide surface of the upstream guide member 91 when the shutter 60 is in the closed state. Therefore, also in this case, it is possible to prevent inadvertent operation of the shutter 60 as in each of the above-described embodiments. Further, the inclined surface 68 is not limited to a flat surface, and may be a curved surface. Furthermore, the configuration in which the shutter 60 has the inclined surface 68 is not limited to the configuration in which the shutter 60 moves in the vertical direction, and is also applicable to the configuration in which the shutter 60 rotates as illustrated in FIGS. 12 to 20.

### Modification of Guide Member

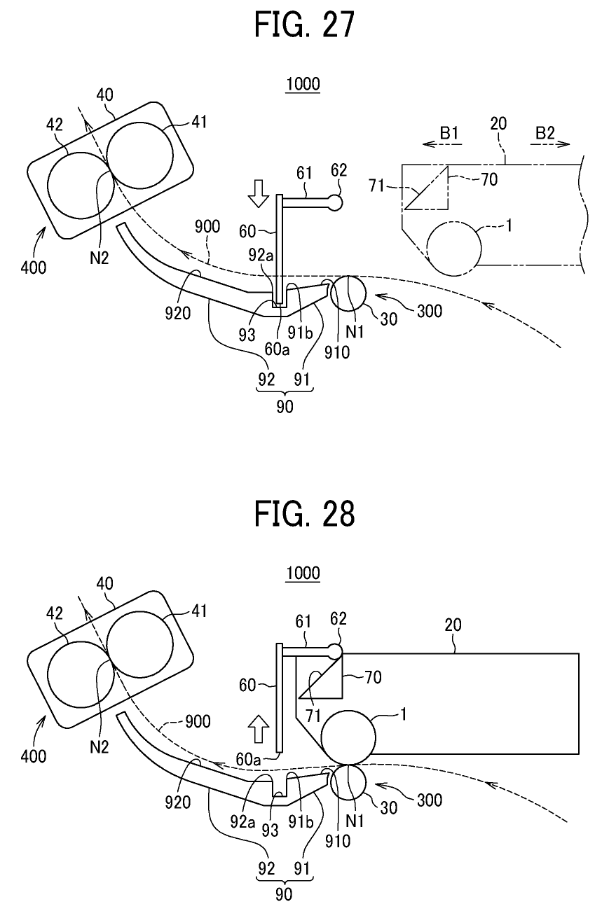

Next, FIGS. 27 and 28 illustrate modifications of the upstream guide member 91 and the downstream guide member 92.

In the examples of FIGS. 27 and 28, the upstream guide member 91 and the downstream guide member 92 are integrally formed as one guide member 90. In this case, a recess 93 is provided between the upstream guide surface 910 and the downstream guide surface 920 of the guide member 90. In this case, when the shutter 60 is switched from the open state in FIG. 28 to the closed state in FIG. 27, the distal end 60a of the shutter 60 enters the recess 93, and thus, the distal end 60a of the shutter 60 is placed at a portion (in the recess 93) recessed from the downstream end 91b of the upstream guide surface 910.

As described above, since the distal end 60a of the shutter 60 in the closed state is placed at a portion (in the recess 93) recessed from the downstream end 91b of the upstream guide surface 910, it is difficult for the operator to touch the distal end 60a of the shutter 60, and thus, it is possible to prevent inadvertent operation (movement) of the shutter 60.

Furthermore, here, the configuration in which the shutter 60 moves in the vertical direction has been described as an example, but such a configuration in which the upstream guide member 91 and the downstream guide member 92 are integrated is not limited to the configuration in which the shutter 60 moves in the vertical direction, and is also applicable to a configuration in which the shutter 60 rotates as illustrated in FIGS. 12 to 20.

Although the image forming apparatus according to some embodiments and modifications of the present disclosure has been described above, the image forming apparatus according to the present disclosure is not limited to the above-described embodiments and modifications, and can be modified in design as appropriate without departing from the gist of the present disclosure.

In the above-described embodiment, the switching between the closed state and the open state of the shutter 60 is performed by the attachment/detachment operation of the image forming unit 20, but the attachment member that switches the shutter 60 may be a member other than the image forming unit 20. For example, in a case where a transfer unit for transferring an image to a sheet, a waste toner container for storing waste toner, and the like are detachable from the apparatus body (image forming apparatus body) 600, the shutter 60 may be switched by an attachment/detachment operation of an attachment member such as the transfer unit or the waste toner container. Furthermore, the shutter 60 is not limited to one that moves in the vertical direction, and may be one that moves in a horizontal direction or an oblique direction. The present disclosure is similarly applicable to an image forming apparatus having such a configuration.

The present disclosure includes at least the following aspects.

Aspect 1

According to Aspect 1, an image forming apparatus includes: a transfer unit to transfer a toner image to a sheet; a fixing unit to fix the toner image, which having been transferred to the sheet, on the sheet; an attachment member detachably attached to an apparatus body; a guide member including a guide surface to guide the sheet conveyed from the transfer unit to the fixing unit; and a shutter switchable between a closed state in which the shutter approaches the guide member and enters a sheet conveyance path between the transfer unit and the fixing unit, and an open state in which the shutter is placed at a position farther from the guide member and more retracted from the sheet conveyance path than in the closed state. The shutter is switched to the open state in conjunction with an attachment operation of the attachment member to the apparatus body, and is switched to the closed state in conjunction with a detachment operation of the attachment member from the apparatus body. The guide surface includes an upstream guide surface upstream from the shutter in a sheet conveyance direction and downstream from the transfer unit in the sheet conveyance direction, and in the closed state, an end of the shutter closer to the guide surface is placed at a portion recessed from a downstream end of the upstream guide surface in the sheet conveyance direction.

Aspect 2

According to Aspect 2, in the image forming apparatus of Aspect 1, the shutter is switched between the closed state and the open state by moving straight back and forth in a vertical direction.

Aspect 3

According to Aspect 3, in the image forming apparatus of Aspect 1, the shutter is switched between the closed state and the open state by being rotated.

Aspect 4

According to Aspect 4, the image forming apparatus of Aspect 3 further includes a rotation restrictor that, when the shutter is in the closed state, restricts the shutter from rotating in a direction opposite to a direction in which the shutter rotates to the open state.

Aspect 5

According to Aspect 5, in the image forming apparatus of any one of Aspects 1 to 4, the guide member includes an upstream guide member upstream from the shutter in the sheet conveyance direction, and a downstream guide member downstream from the upstream guide member in the sheet conveyance direction, and an upstream end of a guide surface of the downstream guide member in the sheet conveyance direction is disposed at a position lower than a downstream end of a guide surface of the upstream guide member in the sheet conveyance direction, to from the portion recessed.

Aspect 6

According to Aspect 6, in the image forming apparatus of any one of Aspects 1 to 4, the guide member includes an upstream guide member provided upstream from the shutter in the sheet conveyance direction and a downstream guide member provided downstream from the upstream guide member in the sheet conveyance direction, the upstream guide member being integral with the downstream guide member, and the portion recessed is a recess disposed between a guide surface of the upstream guide member and a guide surface of the downstream guide member.

Aspect 7

According to Aspect 7, in the image forming apparatus of any one of Aspects 1 to 6, the attachment member includes a shutter operating part to contact a contact portion of the shutter to switch the shutter from the closed state to the open state when the attachment member is installed to the apparatus body.

Aspect 8

According to Aspect 8, in the image forming apparatus of Aspect 2, the shutter includes an actuation projection provided with a contact portion, the attachment member includes a shutter operating part provided with an inclined surface portion, and when the attachment member is installed to the apparatus body, the contact portion contacts the inclined surface portion, the actuation projection is pushed up along the inclined surface portion, and the shutter is switched from the closed state to the open state.

Aspect 9

According to Aspect 9, in the image forming apparatus of Aspect 7 or Aspect 8, in the closed state, the contact portion is placed outside a sheet conveyance region where the sheet is conveyed.

Aspect 10

According to Aspect 10, in the image forming apparatus of any one of Aspects 7 to 9, in the closed state, the contact portion is placed outward of an attachment space, to which the attachment member is attached, with respect to a partition wall that defines the attachment space.

Aspect 11

According to Aspect 11, the image forming apparatus of Aspect 1 includes a wall to cover the shutter from a same side as the transfer unit with respect to the shutter in the sheet conveyance direction when the shutter is in the closed state. The shutter is switchable between the closed state and the open state by rotating about a support shaft, the attachment member includes a shutter operating part to contact a contact portion of the shutter to switch the shutter from the closed state to the open state when the attachment member is installed to the apparatus body. The wall has an opening that allows the shutter operating part to enter when the shutter operating part comes into contact with the contact portion. The wall is disposed to cover a portion of the shutter that is on a side opposite a side closer to the guide surface of the shutter than the support shaft.

Aspect 12

According to Aspect 12, in the image forming apparatus of Aspect 2, the attachment member includes: a shutter operating part to contacts a contact portion of the shutter to switch the shutter from the closed state to the open state when the attachment member is installed to the apparatus body; and a positioner positioned to be a rotation axis in a state in which the attachment member is attached to the apparatus body. When viewed in an axial direction with the positioner as the rotation axis, the positioner is placed on a vertical line extending perpendicularly to a contact surface of the shutter operating part from a contact point where the contact portion of the shutter in the open state contacts the contact surface of the shutter operating part.

Aspect 13

According to Aspect 13, in the image forming apparatus of Aspect 2, the attachment member includes: a shutter operating part to contact a contact portion of the shutter to switch the shutter from the closed state to the open state when the attachment member is installed to the apparatus body; a first positioner positioned to be a rotation axis in a state in which the attachment member is attached to the apparatus body; and a second positioner to restrict rotation with the first positioner as the rotation axis. The first positioner is placed at a position closer to the transfer unit than a vertical line extending perpendicularly to a contact surface of the shutter operating part from a contact point where the contact portion of the shutter in the open state contacts the contact surface of the shutter operating part, when viewed from an axial direction with the first positioner as the rotation axis. When the shutter is in the open state, the second positioner is positioned in contact with a contact portion of the apparatus body by a rotational moment generated around the first positioner.

Aspect 14

According to Aspect 14, in the image forming apparatus of any one of Aspects 1 to 13, the shutter includes an inclined surface that is inclined to a side on which the transfer unit is disposed, toward the end closer to the guide surface.

Aspect 15

According to Aspect 15, in the image forming apparatus of Aspect 14, the shutter includes a bent portion in which the end closer to the guide surface is bent downstream in the sheet conveyance direction, and the bent portion has the inclined surface, and the inclined surface is inclined to approach the guide surface from downstream to upstream in the sheet conveyance direction.

Aspect 16

According to Aspect 16, in the image forming apparatus of any one of Aspects 1 to 15, in the closed state, the end of the shutter closer to the guide surface is placed within 5 mm downstream, in the sheet conveyance direction, from a downstream end of the upstream guide surface in the sheet conveyance direction.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. An image forming apparatus, comprising:
an apparatus body;
a transfer unit to transfer a toner image to a sheet;
a fixing unit to fix the toner image on the sheet;
an attachment member detachably attached to the apparatus body;
a guide member including a guide surface to guide the sheet conveyed from the transfer unit to the fixing unit; and
a shutter to switch between a closed state in which the shutter approaches the guide member and enters a sheet conveyance path between the transfer unit and the fixing unit, and an open state in which the shutter is farther from the guide member than in the closed state and retracted from the sheet conveyance path,
wherein the shutter switches to the open state in conjunction with an attachment operation of the attachment member to the apparatus body, and switches to the closed state in conjunction with a detachment operation of the attachment member from the apparatus body,
the guide surface includes an upstream guide surface upstream from the shutter and downstream from the transfer unit in a sheet conveyance direction, and
when the shutter is in the closed state, a first end of the shutter closer to the guide surface than a second end opposite the first end is placed at a portion recessed from a downstream end of the upstream guide surface in the sheet conveyance direction.

2. The image forming apparatus according to claim 1,
wherein the shutter moves straight back and forth in a vertical direction to switch between the closed state and the open state.

3. The image forming apparatus according to claim 1,
wherein the shutter rotates to switch between the closed state and the open state by being rotated.

4. The image forming apparatus according to claim 3, further comprising a rotation restrictor to restrict the shutter from rotating in a direction opposite to a direction in which the shutter rotates to the open state, when the shutter is in the closed state.

5. The image forming apparatus according to claim 1,
wherein the guide member includes:
an upstream guide member upstream from the shutter in the sheet conveyance direction; and
a downstream guide member downstream from the upstream guide member in the sheet conveyance direction, and
an upstream end of a guide surface of the downstream guide member in the sheet conveyance direction is disposed at a position lower than a downstream end of a guide surface of the upstream guide member in the sheet conveyance direction, to form the portion recessed.

6. The image forming apparatus according to claim 1,
wherein the guide member includes:
an upstream guide member upstream from the shutter in the sheet conveyance direction; and
a downstream guide member downstream from the upstream guide member in the sheet conveyance direction,
the upstream guide member is integral with the downstream guide member, and
the portion recessed is a recess between a guide surface of the upstream guide member and a guide surface of the downstream guide member.

7. The image forming apparatus according to claim 1,
wherein the attachment member includes a shutter operating part to contact a contact portion of the shutter to switch the shutter from the closed state to the open state when the attachment member is installed to the apparatus body.

8. The image forming apparatus according to claim 2,
wherein the shutter includes an actuation projection having a contact portion,
the attachment member includes a shutter operating part having an inclined surface portion, and
when the attachment member is installed to the apparatus body, the contact portion contacts the inclined surface portion, the actuation projection is pushed up along the inclined surface portion, and the shutter is switched from the closed state to the open state.

9. The image forming apparatus according to claim 7,
wherein in the closed state, the contact portion is placed outside a sheet conveyance region where the sheet is conveyed.

10. The image forming apparatus according to claim 7, further comprising a partition wall that defines an attachment space of the apparatus body to which the attachment member is attached,
wherein when the shutter is in the closed state, the contact portion is placed outward of the attachment space with respect to the partition wall.

11. The image forming apparatus according to claim 1, further comprising
a wall to cover the shutter from a same side as the transfer unit with respect to the shutter in the sheet conveyance direction when the shutter is in the closed state,
wherein the shutter rotates about a support shaft to switch between the closed state and the open state,
the attachment member includes a shutter operating part to contact a contact portion of the shutter to switch the shutter from the closed state to the open state, when the attachment member is installed to the apparatus body,
the wall has an opening that allows the shutter operating part to enter when the shutter operating part contacts the contact portion of the shutter, and
the wall is disposed to cover a portion of the shutter that is on a side opposite a side closer to the guide surface of the shutter than the support shaft.

12. The image forming apparatus according to claim 2,
wherein the attachment member includes:
a shutter operating part to contact a contact portion of the shutter to switch the shutter from the closed state to the open state when the attachment member is installed to the apparatus body; and
a positioner positioned to be a rotation axis in a state in which the attachment member is attached to the apparatus body, and
when viewed in an axial direction with the positioner as the rotation axis, the positioner is positioned on a vertical line extending perpendicularly to a contact surface of the shutter operating part from a contact point where the contact portion of the shutter contacts the contact surface of the shutter operating part when the shutter is in the open state.

13. The image forming apparatus according to claim 2,
wherein the attachment member includes:
a shutter operating part to contact a contact portion of the shutter to switch the shutter from the closed state to the open state when the attachment member is installed to the apparatus body;
a first positioner positioned to be a rotation axis in a state in which the attachment member is attached to the apparatus body; and
a second positioner to restrict the attachment member from rotating with the first positioner as the rotation axis,
the first positioner is positioned closer to the transfer unit than a vertical line extending perpendicularly to a contact surface of the shutter operating part from a contact point where the contact portion of the shutter in the open state contacts the contact surface of the shutter operating part,
when viewed from an axial direction with the first positioner as the rotation axis, and
when the shutter is in the open state, the second positioner is positioned in contact with a contact portion of the apparatus body by a rotational moment generated around the first positioner.

14. The image forming apparatus according to claim 1,
wherein the shutter includes an inclined surface that is inclined to a side on which the transfer unit is disposed with respect to the shutter, toward the first end closer to the guide surface.

15. The image forming apparatus according to claim 14,
wherein the shutter includes a bent portion in which the first end closer to the guide surface is bent downstream in the sheet conveyance direction, and
the bent portion has the inclined surface, and the inclined surface is inclined to approach the guide surface from downstream to upstream in the sheet conveyance direction.

16. The image forming apparatus according to claim 1,
wherein when the shutter is in the closed state, the first end of the shutter closer to the guide surface is placed within 5 mm downstream from the downstream end of the upstream guide surface in the sheet conveyance direction.
